(19) United States
(12) Patent Application Publication
(10) Pub. No.: US 2003/0138104 A1
(43) Pub. Date: Jul. 24, 2003

(54) Method for transmission of data including compressed fax and image data

(76) Inventor: Karl M. Marks, Medford, MA (US)

Correspondence Address: c/o MINTZ, LEVIN, One Financial Center, Boston, MA, 02111, US

(21) Appl. No.: 10/200,606

(22) Filed: Jul. 22, 2002

Related U.S. Application Data
(63) Continuation of application No. 08/996,452, filed on Dec. 23, 1997, now abandoned.

(30) Foreign Application Priority Data
Dec. 24, 1996 (DE) DE196 54 342.8-31

(51) Int. Cl. H04N 1/44

(52) U.S. Cl. 380/243

(57) ABSTRACT

Embodiments of the present invention described herein relate to a method of fax and image data transmission, wherein the data are compressed using adaptive arithmetic compression algorithms. To achieve a simultaneous, secure encryption while compressing the data both a transmitter and a receiver use a same initialization of compression parameters and tables, which differs from a standard initialization and which is defined or referenced by encryption parameters. The encryption parameters are separately transmitted from the sender to the receiver for security and are used by the receiver to properly decode the encrypted data.

### FIELD OF THE INVENTION

The present invention relates generally to transmission of facsimile (fax) or image data, and more specifically to a method for compressing and encrypting data using adaptive arithmetic compression.

### SUMMARY OF THE INVENTION

Embodiments of the present invention described herein relate to a method of fax and image data transmission, wherein the data are compressed using adaptive arithmetic compression algorithms. To achieve a simultaneous, secure encryption while compressing the data, in embodiments of the present invention that are based on a common compression algorithm, both a sender and a receiver use a same initialization of compression parameters and tables, which differs from a standard initialization and which is defined or referenced by encryption parameters. The encryption parameters are separately transmitted from the sender to the receiver for security and are used by the receiver to properly decode the encrypted data.

### BRIEF DESCRIPTION OF THE DRAWING

For a better understanding of the present invention, reference is made to the drawing which is incorporated herein by reference and in which:

FIG. 1 is a block diagram of a method in accordance with one embodiment of the present invention.

### DETAILED DESCRIPTION

Currently used fax compression methods are becoming obsolete because of a new fax industry standard. This new fax standard, known as T.85 will be based on an arithmetic compression standard named JBIG (ISO 11544). JBIG, as well as its predecessor ABIC, are adaptive arithmetic compression methods, that convert an image data stream into a binary fraction. This is accomplished in two steps, an image preprocessing step and a subsequent adaptive arithmetic coding step.

The image preprocessing step extracts individual image pixels and converts them into context bits correlated with neighboring pixels. Or in other words, each individual pixel of the complete image has additional information describing the neighboring pixels as well as their special relationship. At the edges of a data matrix or an image, special rules apply for context bits located outside the actual image or data matrix. For each pixel, JBIG uses 10 neighboring pixels to generate context bits. The neighboring pixels are taken either from a previous line and the current line or from the two previous lines and the current line. In addition, one context bit from the previous line may be replaced by a more distant pixel in the current line to pick up horizontal frequencies to improve the compression ratio. These options are programmable parameters.

An example of how each image pixel is associated with its context is provided in the IBM, Journal of Research and Development, Volume 32, Number 6, November 1988. Pages 779 and 780 of the IBM Journal show how each image pixel is associated with a context and how they are generated. In FIG. 3 on page 778 of this publication, the procedures for both compression and decompression of data are described. An adaptive arithmetic coder consists of an adapter and the so called arithmetic coder. The adapter contains a storage table memory, which, for example, in the case of JBIG has 1024 (2\hat{ }10) entries. The context bits are used as an index into this table memory. The information stored in each entry of the table are the expected value for the current pixel given the surrounding pixel values defined by the context and a probability index for this expected value. Both the probability indices and the expected values are adapted dynamically to optimize compression. The probability indices are converted into a binary fraction that can be viewed as an interval width. The higher the probability of an expected value, the lower is the information content of an event confirming the expected value and accordingly the chosen size for the corresponding interval. For each image pixel being coded, the adapter passes the interval size Qe and a flag, specifying whether the expectation for this image pixel has been met or not, to the arithmetic coder.

The arithmetic coder contains an accumulator C to generate the compressed code word as well as an accumulator A for tracking the actual interval width. Initial conditions are C=0 and A=1.0000. For each pixel being coded, the interval width is adapted; if the pixel meets the expected value, the value in A is replaced by A-Qe, otherwise the value in A is replaced by Qe. Similarly, the value in C is replaced by C+Qe, otherwise, it retains its initial value. Whenever A drops below 0.5, both A and C are shifted left until A is larger than 0.5 again. This allows generation of a binary fraction of infinite precision with an accumulator of finite precision. The compression of the coding is based on the fact, that for pixels with a high probability for the expected value, Qe is very small, and therefore can be subtracted many times from A before an underflow occurs and the simultaneous renormalization of C with A generates code bits.

Decoding works accordingly by loading C with an accumulated code word. Then an attempt is made to subtract Qe from C. If Qe can be subtracted from C without causing C to underflow, it must have been added during encoding, i.e. the pixel being coded equaled the expected value; otherwise, C retains its value, and the pixel being coded did not equal the expected value. A is processed in a similar manner during encoding.

Embodiments of the present invention described herein are based on the compression method described above. The compression and subsequent decompression method described above does not suggest any mechanisms to encrypt transmitted data in such a way that only authorized receivers can read and reconstruct the data. The purpose of embodiments of the present invention is to provide a method that simultaneously provides compression and encryption of data.

In embodiments of the present invention, both a transmitter and a receiver perform compression and decompression using a same, pre-negotiated initialization of context parameters, data formatting options and adapter table, which deviate from the initializations established by the JBIG standard. The standard compression method is thus turned into a simultaneous encryption method by using deviations from the standard initial conditions as encryption parameters.

In embodiments of the present invention, a method is provided wherein a transmitter and a receiver negotiate upfront, which deviations of context parameters, data formatting options and the adapter table with its 8192 bits will be used, thus, providing more than 2\hat{ }8192 possible deviations from the standard initial conditions. Such a code space complexity is considered secure, because it cannot be recovered with available computer power. In addition, the sequentiality of code generation, which causes an unpredictable, data dependent, propagation of any error introduced by the deviating initialization constitutes an additional security factor of this method. Furthermore, the described method does not require any additional computational resources beyond those required for the implementation of the JBIG compression standard; i.e. the simultaneous encryption does not require additional hardware or computational cycles over that typically required for the pure compression of data, thereby minimizing cost for the encryption.

Although the arithmetic compression methods in the form described were primarily developed for image data compression, they are suitable for other data formats as well. An advantage of the adaptive nature of this methods described above is that compression ratios do not drop below 0.85. Thus, even for non-image data that does not compress efficiently, the described methods can be used for general data encryption with a maximal overhead of approximately 15%. In general compression factors below 1.0 are extremely rare.

In embodiments of the present invention, there is a selection of the encryption parameters and their usage in the transmitter. Encryption parameters is the collective naming for a variety of possibilities to influence the encryption. These parameters include the initial adapter table entries and the standard parameters such as template definition or image format, each of which can be used to provide encryption in embodiments of the present invention. It is preferred, to maintain encryption security, that the set of encryption parameters be transmitted separately, or be negotiated upfront between the sender and the receiver.

In one embodiment, sets of encryption parameters are available locally at the transmitter and the receiver, and are identified by a common encryption reference, either predetermined, or sent separate from compressed, encrypted data. During actual transmission of compressed, encrypted data, any recipient of the data, other than the intended recipient, will not be able to uncompress the data since the common encryption parameters referenced by the transmitted encryption reference are not transmitted themselves with the data.

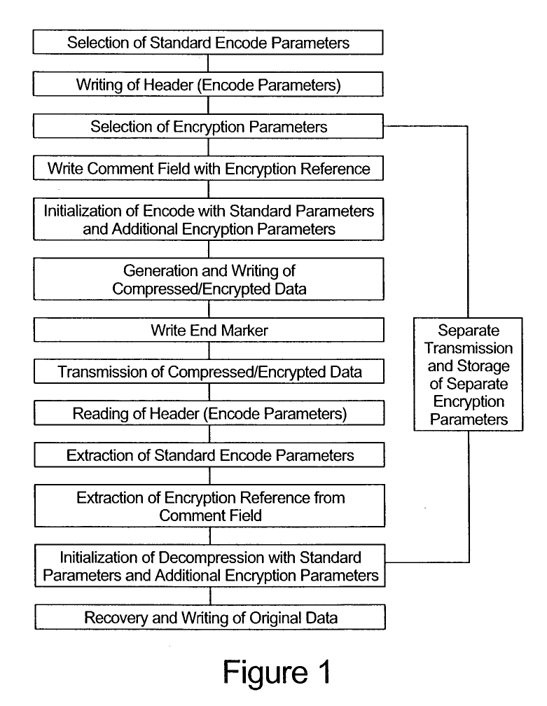

The procedural flow of the method in accordance with one embodiment of the present invention will now be described with reference to FIG. 1, which shows a flow diagram of the method. The procedural steps marked with a star are those added to the standard JBIG cycle. Thus, the procedural steps marked with a star constitute the specific steps required according to embodiments of the invention, and their position in the flow diagram manifest their procedural integration into the procedure already known from the JBIG standard.

First, standard encode parameters are selected. These are generated in accordance with standard procedures. As a second step a header is written containing the selected encode parameters. In a third step encryption parameters are determined or selected. These are computational resources beyond those required for the implementation of the JBIG compression standard; i.e. the simultaneous encryption does not require additional hardware or computational cycles over that typically required for the pure compression of data, thereby minimizing cost for the encryption.

Although the arithmetic compression methods in the form described were primarily developed for image data compression, they are suitable for other data formats as well. An advantage of the adaptive nature of this methods described above is that compression ratios do not drop below 0.85. Thus, even for non-image data that does not compress efficiently, the described methods can be used for general data encryption with a maximal overhead of approximately 15%. In general compression factors below 1.0 are extremely rare.

In embodiments of the present invention, there is a selection of the encryption parameters and their usage in the transmitter. Encryption parameters is the collective naming for a variety of possibilities to influence the encryption. These parameters include the initial adapter table entries and the standard parameters such as template definition or image format, each of which can be used to provide encryption in embodiments of the present invention. It is preferred, to maintain encryption security, that the set of encryption parameters be transmitted separately, or be negotiated upfront between the sender and the receiver.

In one embodiment, sets of encryption parameters are available locally at the transmitter and the receiver, and are identified by a common encryption reference, either predetermined, or sent separate from compressed, encrypted data. During actual transmission of compressed, encrypted data, any recipient of the data, other than the intended recipient, will not be able to uncompress the data since the common encryption parameters referenced by the transmitted encryption reference are not transmitted themselves with the data.

The procedural flow of the method in accordance with one embodiment of the present invention will now be described with reference to FIG. 1, which shows a flow diagram of the method. The procedural steps marked with a star are those added to the standard JBIG cycle. Thus, the procedural steps marked with a star constitute the specific steps required according to embodiments of the invention, and their position in the flow diagram manifest their procedural integration into the procedure already known from the JBIG standard.

First, standard encode parameters are selected. These are generated in accordance with standard procedures. As a second step a header is written containing the selected encode parameters. In a third step encryption parameters are determined or selected. These are assigned a reference and then are or have been sent to the receiver and stored separately. The encryption reference is added to the header as a comment field. Next the compression unit is initialized with the selected standard parameters and the additional encryption parameters. Subsequently the compressed and, according to the invention, encrypted data are generated. This process ends with the writing of an end marker. Then, the compressed and encrypted data are transmitted. The transmission as well as the steps taking place in the receiver are shown with a gray background to distinguish them from steps taking place in the transmitter. The receiver first reads the header described above, which contains the selected encode parameters, and extracts these parameters. According to the invention this is followed by a step of extracting the encryption reference from the comment field.

Next the decompression unit is initialized with the extracted standard parameters as well as the referenced encryption parameters. For this step, the separately transmitted or generated and stored encryption parameter set pointed to by the reference is used. Then the decode process retrieves and stores the original data, data field or image data. The separately transmitted or generated encryption parameters can be stored either in the receiver or transmitter so that they are retrieved or transmitted separately when initializing the decode process. Additional security may be established by a process where the receiver has to request these parameters from the sender in a separate transmission process. It may be advantageous to conduct this transmission not sequentially on the same channel, but using a separate channel or completely different transmission medium.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for transmitting data from a transmitter to a receiver, wherein the data includes at least one of facsimile data and image data, the method comprising steps of:
initializing standard compression parameters including context parameters, data format parameters and adapter table entries;
initializing additional parameters for encryption;
compressing and encrypting the data using adaptive arithmetic compression and using the standard compression parameters and the additional parameters to create compressed, encrypted data; and
transmitting the compressed, encrypted data to the receiver;
wherein the additional parameters are transmitted separately from the compressed, encrypted data.

2. The method of claim 1, wherein the step of initializing additional parameters includes a step of selecting a set of encryption parameters identified by a reference value, and wherein the step of transmitting includes a step of transmitting the reference value to the receiver with the compressed, encrypted data.

3. The method of claim 2, further comprising steps of:
receiving the compressed, encrypted data and the reference value in the receiver;
extracting the reference value from the encrypted data;
selecting the set of encryption parameters identified by the reference value from the additional parameters transmitted separately from the compressed, encrypted data; and
using the set of encryption parameters to decrypt the compressed, encrypted data.

4. The method of claim 3, further comprising steps of:
storing the additional parameters in the receiver; and
retrieving the additional parameters from storage upon initialization of decompression of the compressed, encrypted data in the receivor.

5. The method of claim 4, further comprising steps of:
sending a request from the receiver to the sender for the additional parameters; and
receiving the additional parameters in the receiver in response to the request.

6. The method of claim 1, wherein the compressed, encrypted data is transmitted using a first transmission path and the additional parameters are transmitted using a second transmission path different from the first transmission path.

7. The method of claim 1, wherein the compressing and encrypting is conducted using standard compression hardware.
